(19) United States
(12) Patent Application Publication
(10) Pub. No.: US 2008/0173183 A1
(43) Pub. Date: Jul. 24, 2008

(54) Portable Tea Seat with Observation Window

(76) Inventor: Chia-Sheng Chen, Fongshan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/942,971

(22) Filed: Nov. 20, 2007

(30) Foreign Application Priority Data
Jan. 19, 2007 (TW) 096102176

(51) Int. Cl. A47J 31/00

(52) U.S. Cl. 99/285

(57) ABSTRACT

This invention relates to a portable tea set with observation window, which is comprised by upper cap, tealeaves vessel, teacup and lower cap, featuring in: said tealeaves vessel is equipped with a one-body molded U-shaped filter sieve and an observation window outside, so that you can observe how tea is prepared and U-shaped filter sieve can filter tealeaves and tea water automatically, besides, bottom of tealeaves vessel and internal screw thread of lower cap can interact with top of teacup and bottom of external screw thread, thus, whole tea set can be assembled as required, in addition, owing to its small capacity and combination of whole structure, such tea set is portable and convenient to prepare tea water; meanwhile, it can separate tealeaves from tea water, so that tealeaves shall not be soaked in high temperature water for long time, quality of tealeaves can be preserved accordingly.

### BACKGROUND OF THE INVENTION

1) Field of the Invention

This invention relates to a portable tea set with observation window, particularly relates to tea set with observation window and U-shaped filter sieve, so that you can observe how tea is prepared and U-shaped filter sieve can filter tealeaves and tea water automatically, furthermore, tea set can be combined as required, thus, tealeaves and tea water can be separated after prepared, tealeaves shall not be soaked in tea water continuously, and the separated tealeaves are kept in tea vessel, meanwhile, said tealeaves vessel can be assembled with bottom of teacup with tea water, therefore, the soaked tealeaves can be kept in tea set, thus, this invention is economic and practical.

2) Description of the Prior Art

People usually prepare tea water with teapot and teacup. However, it wastes of time to prepare tea water and require kinds of tea set, which are only suitable for home or fixed location but not portable; though tea set with filter sieve and steel balls filtering the soaked object is marketable at present, however, said steel balls shall produce clearance due to long time use or man-made factor resulting that boiled water may leak from steel ball at bottom of teacup to scald user prior to preparation of tea water, besides, tealeaves and tea water can be separated but must drink tea water solely, and tealeaves have to place beside, if want to go to another location at this moment, because said teacup can not be combined with teapot, the just prepared tea water has to pour away, so, such tea set is not portable.

### SUMMARY OF THE INVENTION

Because above said disadvantages and inconvenience of tea set produced are different from customer's habit to prepare tea water, the inventor has made following invention after years' tests and experiments, which is described as follows:

Please refer to FIG. 1, FIG. 2 and FIG. 6, tea set (5) of this invention is changeable, which can be assembled into tea set as shown in FIG. 2, FIG. 3, FIG. 4 and FIG. 5 as required, please refer to FIG. 1 and FIG. 6. Besides, tealeaves vessel (2) also has a one-body molded U-shaped filter sieve (8) and an observation window (201) to observe how tea is prepared in teacup, tealeaves (9) and tea water (12) will be automatically separated (as shown in FIG. 9) however, prior art of teacup couldn't do so; in addition, soaked tealeaves (9) is contained in said tealeaves vessel (2) which is capable to screw off teacup (3) independently and place it beside as shown in FIG. 5, therefore, tealeaves (9) would not be suffocated by high temperature water to weaken quality of tealeaves (9). In case you have to be off, said tea water (12) is very hot due to just preparation, it is not economic if poured it away, furthermore, it is also difficult to drink such hot tea water over, in this case, you can just combine tealeaves vessel (2) contained tealeaves (9) with lower cover (4) as shown in FIG. 3, namely, screw tealeaves vessel (2) on bottom of teacup and lower cover (4) is screwed on top of teacup, the just prepared tea water (12) can be poured into teacup (3), tealeaves (9) is also contained in said tealeaves vessel (2), so that whole teacup is combined into one entity that is convenient to carry with. Disadvantages of prior art can be overcome, such tea set is easy to prepare tea water and convenient to carry with.

### OBJECTS OF THE INVENTION

Main object of this invention is to provide a portable tea set with observation window, wherein tealeaves vessel is equipped with a one-body molded U-shaped filter sieve and an observation window, so that you can observe how tea is prepared and U-shaped filter sieve can filter tealeaves and tea water automatically.

Second object of this invention is to provide a portable tea set with observation window, because bottom of tealeaves vessel and internal screw thread of lower cap can interact with top of teacup and bottom of external screw thread, thus, whole tea set can be assembled as required.

Third object of this invention is to provide a portable tea set with observation window, owing to its small capacity and combination of whole structure, such tea set is portable and convenient to prepare tea water while occupying small room.

Fourth object of this invention is to provide a portable tea set with observation window, it is very easy to prepare tea water by turning tea set 180° and soaking tealeaves for minutes and then turning it back to normal. Besides, tea water is separated from tealeaves vessel after prepared, namely, tea water is in teacup and tealeaves is contained in tealeaves vessel separately.

### THE PREFERRED EMBODIMENT OF THE INVENTION

Please refer to FIG. 1 and FIG. 2, this invention relates to a portable tea set with observation window, which is comprised by upper cap (1), tealeaves vessel (2), teacup (3) and lower cap (4). Because internal screw thread (101) is made in internal side of upper cap (1) near bottom (103), so, it can be screwed on external screw thread (203) of top (206) of tealeaves vessel (2); besides, an internal screw thread (204) is made in internal side of bottom (205) of tealeaves vessel (2), so that it can also be screwed on external screw thread (303) of top (305) of teacup (3); furthermore, external screw thread (304) is also made in external side of bottom (306) of teacup (3), so, it can be screwed on internal screw thread (401) of top (403) of lower cap (4). Thus, whole tea set(S) is combined as bellow: upper cap (1) is screwed on tealeaves vessel (2), then said tealeaves vessel (2) is screwed on teacup (3), and then said teacup (3) is screwed on lower cap (4). Therefore, tea set as shown in FIG. 1 can be combined into what is shown in FIG. 2 before preparation of tea water (namely, 1, 2, 3, 4). In addition, internal screw thread (204) at bottom (205) of tealeaves vessel (2) can be interacted with external screw thread (303,304) of bottom (306) and top (305) of teacup (3), so that it can be combined into what is shown in FIG. 3 (namely, 4, 3, 2, 1), or assembled separately as shown in FIG. 4 (namely, 4 and 3), or as shown in FIG. 5 (namely, 2 and 1). Thus, tea set of this invention is possible to be assembled as required by users. Please refer to FIG. 6, one-body molded U-shaped filter sieve (8) is assembled in tealeaves vessel (2), and fixing block (7) presses down filter-fixing plate (801) to fix said U-shaped filter sieve (8) at internal wall of tealeaves vessel (2), and an observation window (201) is made at a proper position of external wall, which is to observe how tealeaves are soaked in boiled water (10) in tealeaves vessel (2); besides, internal screw thread (204) is made in internal side of bottom (205) of tealeaves vessel (2), so, please first screw off upper cap (1) of tea set (5) as shown in FIG. 2 to put tealeaves into it, and then screw it on when preparing tea water (FIG. 2 is changed into FIG. 7) as shown in FIG. 7, after that, screw off upper cap (1) of tea set (5) to pour boiled water (10) into container (301) of teacup (3) up to level (1001) as shown in figure, and then screw said tealeaves vessel (2) on top of teacup (3) as shown in FIG. 7; after prepared tealeaves (9) and boiled water (10) as shown in FIG. 7, turn the combined device of FIG. 7 about 180° as shown in FIG. 8, boiled water (10) formerly poured into container (301) of teacup (3) flow downward into tealeaves vessel (2) to mix with tealeaves (9), and tealeaves (9) is soaked in boiled water; since a washer (6) is assembled in upper cap (1), top (206) of said tealeaves vessel (2) can lean against said washer (6) after screwed on, so, boiled water (10) poured into tealeaves vessel (2) wouldn't leak, meanwhile, since there is a fixing block (7) in said tealeaves vessel (2), so, top (305) of said teacup (3) can lean against said fixing block (7) after top (305) of teacup (3) and tealeaves vessel (2) are screwed on, so, boiled water poured into tealeaves vessel (2) and teacup (3) may not leak between teacup (3) and tealeaves vessel (2); as tealeaves (9) is soaked in boiled water (10) for minutes, you can observe how tealeaves are soaked in tealeaves vessel (2) through observation window (201), as user thinks it is prepared, please turn the reversed tea set as shown in FIG. 8 once again 180° back to its former state as shown in FIG. 9, boiled water in tealeaves vessel (2) may flow downward along the flow direction (1) into container (301) of teacup (3) and become tea water (12), and tealeaves (9) in tealeaves vessel (2) are blocked and filtered by U-shaped filter sieve (8) automatically, meanwhile, tealeaves (9) and tea water (12) can be separated automatically. If want to drink the prepared tea water, you can screw tealeaves vessel (2) soaked tealeaves off teacup (3), and then place it beside you as shown in FIG. 5, tealeaves (9) are therefore free from suffocating in high temperature tea water (12), quality of tealeaves (9) can be ensured accordingly because it is kept in a room temperature.

Please refer to FIG. 1, since upper cap (1), tealeaves vessel (2) and lower cap (4) of tea set (5) are coated with stainless steel sheet (102,202,402), besides, said teacup (3) is structured in vacuum two-deck stainless steel for heat preservation, namely, it has one vacuum part (32), so, if want to drink the prepared tea water (12) as shown in FIG. 9 (said tealeaves vessel (2) has already been screwed off and place beside as mentioned above before drinking), however, it is impossible to drink over once, in this case, you can screw off lower cap (4) of bottom (306) of teacup (3), and then screw it on top (305) of teacup (3) as shown in FIG. 4, so that tea water can be preserved for a long time. If couldn't drink the prepared tea water as shown in FIG. 9 due to urgent reason, tea set can be combined into what is shown in FIG. 3, namely, tea water is contained in container (301) of teacup (3) after screwed upper cap (4) on, and the soaked tealeaves (9) are kept in tealeaves vessel (2), so that it is easy to prepare such tea water as required by user, and such tea set is also convenient to carry away from the original location to prepare tea water. If want to prepare another cup of tea water, just pour boiled water into container (301) of teacup (3) and repeat above said steps.

In addition, if made tealeaves vessel (2) of this invention with transparent material you can observe how tea water is prepared from every corner, so, it needn't make an observation window. Besides, teacup (3) of this invention is structured in vacuum two-deck stainless steel for heat preservation, as a matter of fact, it also can be made from pottery, plastics, plastic glass and glass material in non-vacuum structure; meanwhile, it can be made from pottery, plastics, plastic glass and glass material in single layer and composite double-layer (namely, two layers are adhered to each other).

To sum up all above descriptions, the portable tea set with observation window of this invention not only has novel, practical and simple structure and easy operation but also convenient to carry with, so that it answers to requirements of patent, you will be highly appreciated to approve it.

However, above descriptions only indicate the preferred embodiment of this invention, which will not limit claims of this invention, those relevant applications and changes basing on descriptions of this invention and claims of patent will be included in this invention.

### BRIEF DESCRIPTION OF DRAWINGS

FIG. 1 is the section exploded view of this invention

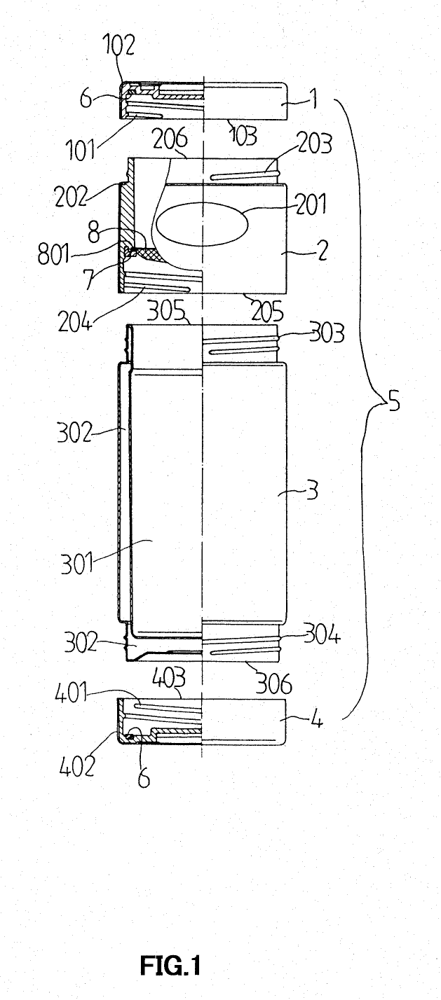

FIG. 2 is the combined section of this invention in normal state (namely, 1, 2, 3, 4)

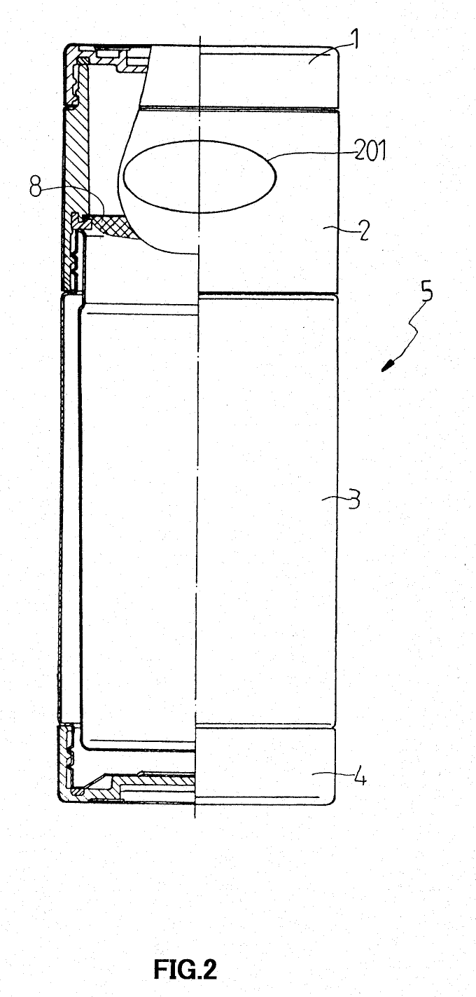

FIG. 3 is the changeable combination of this invention (I) (namely, 4,3,2,1 combination sketch view)

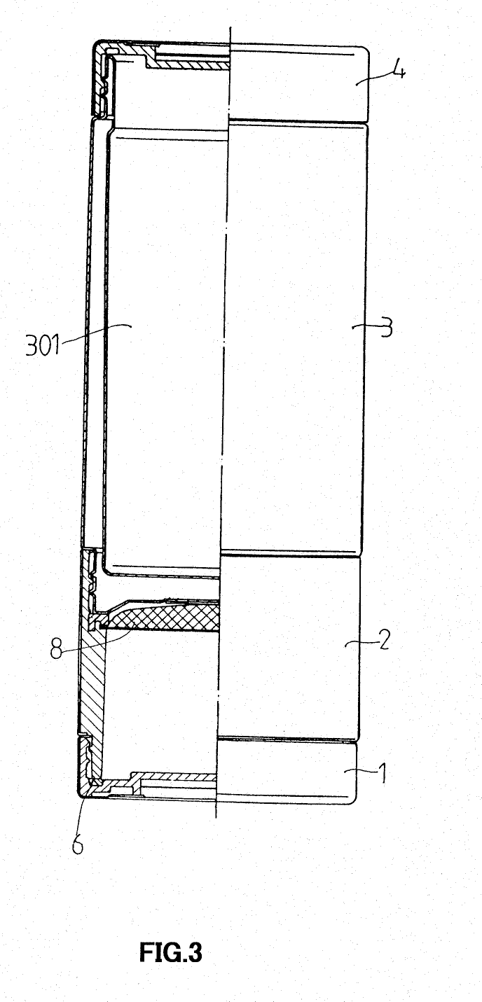

FIG. 4 is the changeable combination of this invention (II) (namely, 4 and 3 combination sketch view)

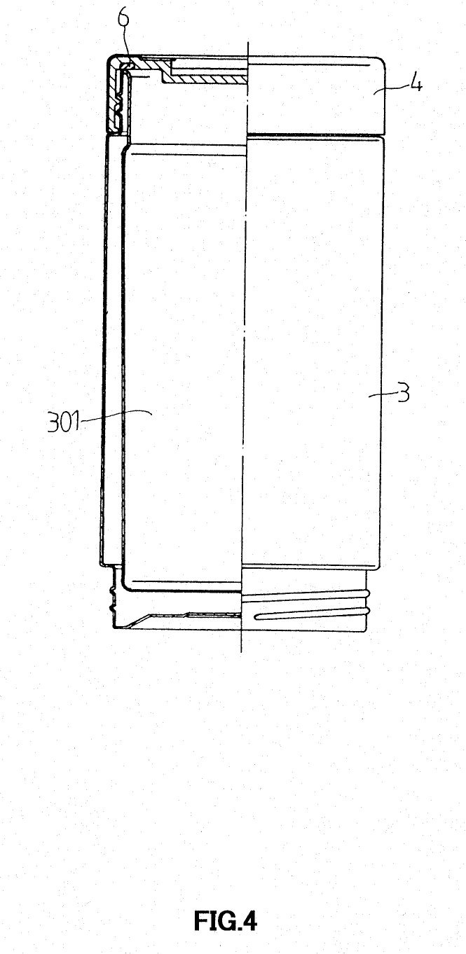

FIG. 5 is the changeable combination of this invention (III) (namely, 2 and 1 combination sketch view)

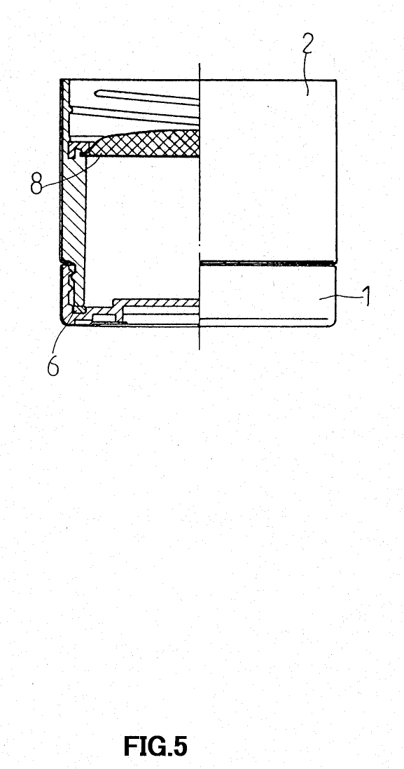

FIG. 6 is the section of tealeaves vessel of this invention

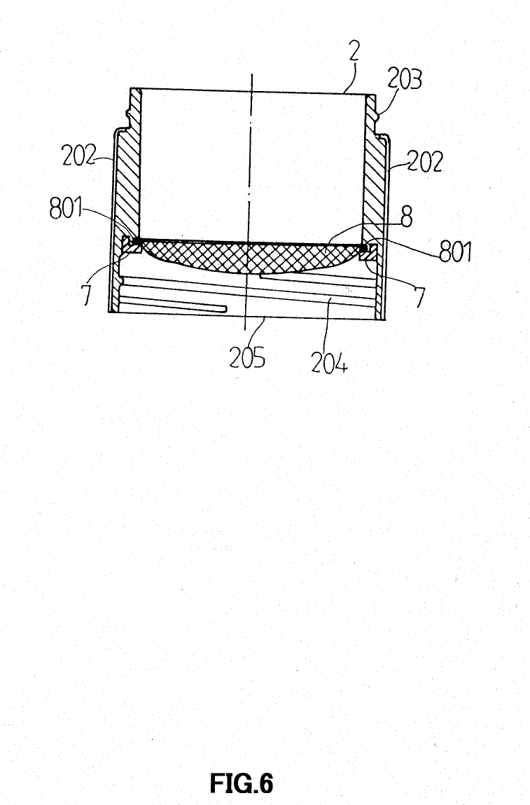

FIG. 7 is the sketch view of combination of this invention to place tealeaves and to pour into boiled water before preparing tea water

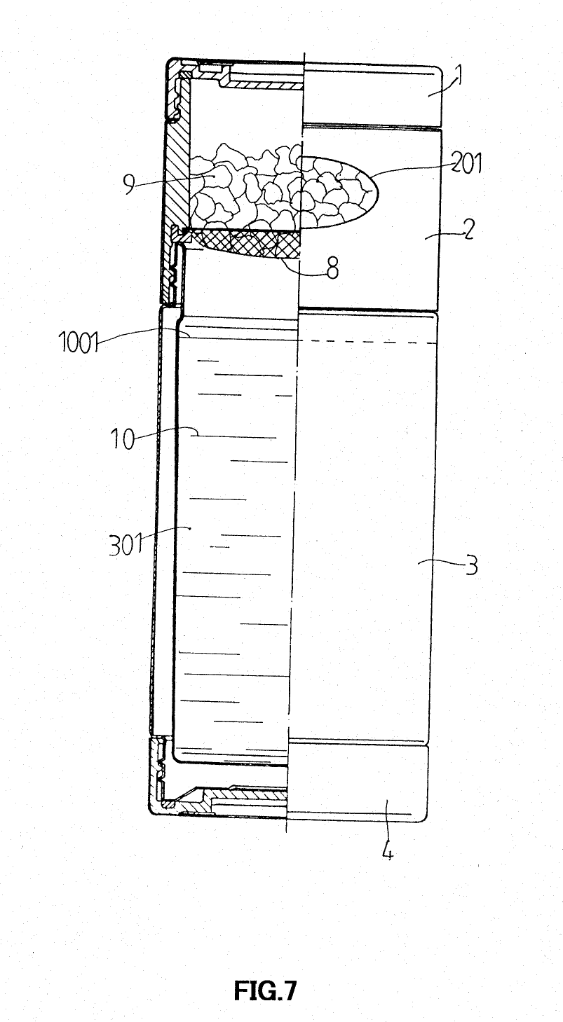

FIG. 8 is the teacup of this invention placing upside down during preparing tea water

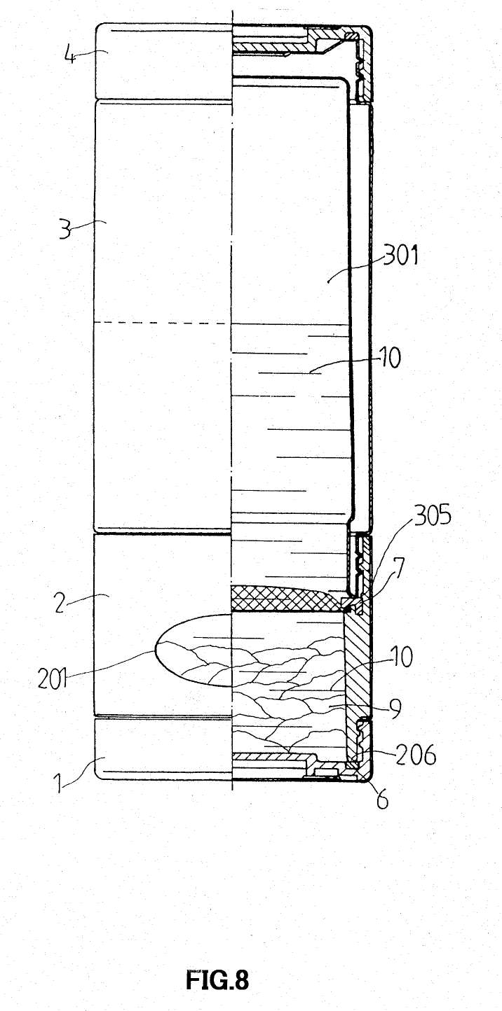

FIG. 9 is the sketch view of this invention that tealeaves and boiled water are separated automatically after prepared.

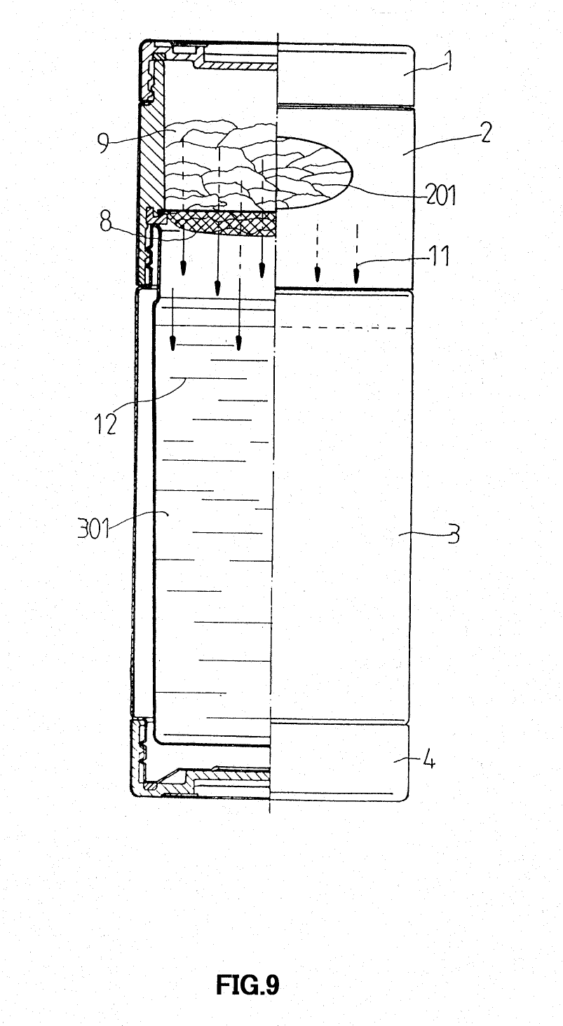

What is claimed is:

1. A portable tea set with observation window, comprising: upper cap, tealeaves vessel teacup and lower cap, featuring in:
Upper cap, which is a round object coated with stainless steel sheet, screw thread is made near bottom, and a groove is made over said screw thread, a washer is placed in said groove;
Tealeaves vessel is a hollow cylinder, external screw thread is made at its top, said external screw thread can screw on internal screw thread of upper cap, and concave internal screw thread is made in bottom, and a one-body molded U-shaped filter sieve is fixed by a fixing block, said U-shaped filter sieve is then fixed by filter-fixing plate, tealeaves is put into said U-shaped filter sieve, tea set is coated by stainless steel sheet externally, an observation window is made at proper position to observe its inside.
Teacup is a cylinder with external screw thread at top, said external screw thread can be screwed on internal screw thread of tealeaves vessel, bottom also has external screw thread which can be screwed on internal screw thread of tealeaves vessel as required, a container in tea set can contain boiled water or prepared tea water, vacuum two-deck stainless steel structure for heat preservation is made around said container.
Lower cap is a round object which is coated with stainless steel sheet, screw thread is made near its top, and also a groove is made at proper position of said internal screw thread, a washer is put into said groove, said internal screw thread can be screwed on external screw thread at bottom of teacup, and it also can be screwed on external screw thread at top of teacup as required.
Therefore, all parts can be screwed on and combined into a tea set by these screw threads. As tealeaves and boiled water are placed properly, just turn the combined tea set 180°, boiled water in teacup may flow backwards into tealeaves vessel to soak tealeaves, you can observe how tea is soaked minutes later, and then, turn tea set 180°, tea water can automatically flow into container of teacup, and tealeaves can be filtered by U-Shaped filter sieve to separate from tea water.

2. Portable tea set of claim 1 wherein said tealeaves vessel is made from transparent material, so that it is transparent for observation, no need to make an observation window.

3. Portable tea set of claim 1 wherein said teacup is made from pottery, plastics, plastic glass and glass material with non-vacuum two-deck structure.

4. Portable tea set of claim 1 wherein said teacup is made from pottery, plastics, plastic glass and glass material in single layer and composite double-layer (namely, two layers are adhered to each other).

5. Portable tea set of claim 1 wherein said internal screw thread at bottom of tealeaves vessel and internal screw thread at top of lower cap can be screwed on external screw thread at top and bottom of teacup as required, so that tea set can be combined into lower cap, teacup, tealeaves vessel and upper cap from top to bottom (namely 4, 3, 2, 1).

6. Portable tea set of claim 1 wherein said tea set can be divided into two parts separately, namely, parts to contain tea water and tealeaves respectively, the part to contain tea water is comprised by tealeaves vessel and upper cap (namely, 2 and 1); the part to contain tealeaves is combined with lower cap and teacup (namely, 4 and 3).
